(19) United States
(12) Patent Application Publication
(10) Pub. No.: US 2007/0271108 A1
(43) Pub. Date: Nov. 22, 2007

(54) Method for optimizing skill development to maximize labor value

(75) Inventors: Christine Broderick, Oak Park, IL (US); Anthony Edward Martinez, St. Augustine, FL (US); Ronald James Salpietra, Huntersville, NC (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 11/436,952

(22) Filed: May 18, 2006

(51) Int. Cl. G06Q 10/00; G06Q 30/00

(52) U.S. Cl. 705/1

(57) ABSTRACT

A computer-implemented method for maximizing labor value in an organization. An exemplary method includes determining a capability level score for an individual in an organization, determining a corresponding labor cost score for the individual, and computing an individual skills value index for the individual. The individual skills value index is the ratio of the capability level score to the labor cost score. The individual skill value index is used to maximize the labor value.

### BACKGROUND OF THE INVENTION

1. Field of the Invention

The present invention relates generally to an improved data processing system and in particular to a method and apparatus for managing a labor force in an organization. Still more particularly, the present invention relates to a computer implemented method, apparatus, and computer usable program code for maximizing labor value in an organization relating the capabilities of an individual or individuals in an organization and the costs associated with that individual or with those individuals.

2. Description of the Related Art

Large organizations and businesses can employ hundreds, even many thousands of individuals. Tracking the skills of those individuals and tracking costs related to those individuals is desirable in order to maximize the efficiency with which a business is operated. For example, compensation should be commensurate with skill or capability level in order to maximize retention of skilled individuals while simultaneously minimizing cost.

The task of performing this professional development analysis is a difficult problem when the organization is large. Thus, professional development analysis software has been developed in an attempt to automate the process of performing professional development analysis. Professional development analysis software can be defined as analysis, reporting, and tracking software mechanisms that provide a consolidated view of the value of an organization's workforce. Professional development analysis software allows an organization to gather, store, access, and analyze workforce capabilities and associated costs to aid in professional development decision making. However, traditional professional development analysis software binds the capability level of individuals in an organization to the cost of employing those individuals. In other words, high capability level correlates to high cost and low capability level correlates to low cost.

However, because business economic factors are not connected to an individual's personal rate of professional development, in terms of acquisition of skill, mismatches between capability level (skills) and compensation grade can occur. These mismatches are undesirable, because the organization can potentially compensate an individual too highly for that individual's capability level. As a result, the organization is not cost effective. On the other hand, an organization can underpay an individual who has a high capability level. As a result, the organization may not be able to retain that individual, which can result in a loss of business effectiveness for the organization.

### SUMMARY OF THE INVENTION

The illustrative embodiments provide a computer-implemented method, computer usable program code, and apparatus for maximizing labor value in an organization. An exemplary method includes determining a capability level score for an individual in an organization, determining a corresponding labor cost score for the individual, and computing an individual skills value index for the individual. The individual skills value index is the ratio of the capability level score to the labor cost score. The individual skill value index is used to maximize the labor value.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which embodiments may be implemented;

FIG. 2 is a block diagram of a data processing system in which embodiments may be implemented;

FIG. 3 is a block diagram showing operation of professional development analysis software, in accordance with an illustrative embodiment;

FIG. 4 is a table showing an exemplary normalized skill value indices that compare normalized capability level scores to normalized labor cost scores, in accordance with an illustrative embodiment.

FIG. 5 is a graph showing an exemplary skills value index distribution for an organization, in accordance with an illustrative embodiment;

FIG. 6 is an exemplary graphical user interface for a professional development analysis software that is capable of calculating and manipulating a skills value index for an organization, in accordance with an illustrative embodiment;

FIG. 7 is a table showing exemplary causes and remedies for misalignment between capability level scores and labor cost scores, in accordance with an illustrative embodiment.

FIG. 8 is a table showing exemplary causes and remedies for misalignment between capability level scores and labor cost scores, in accordance with an illustrative embodiment.

FIG. 9 is a flowchart illustrating an exemplary method of comparing capability level scores and labor cost scores, in accordance with an illustrative embodiment; and

FIG. 10 is a flowchart illustrating an exemplary method of comparing capability level scores and labor cost scores, in accordance with an illustrative embodiment.

### DETAILED DESCRIPTION OF THE PREFERRED EMBODIMENT

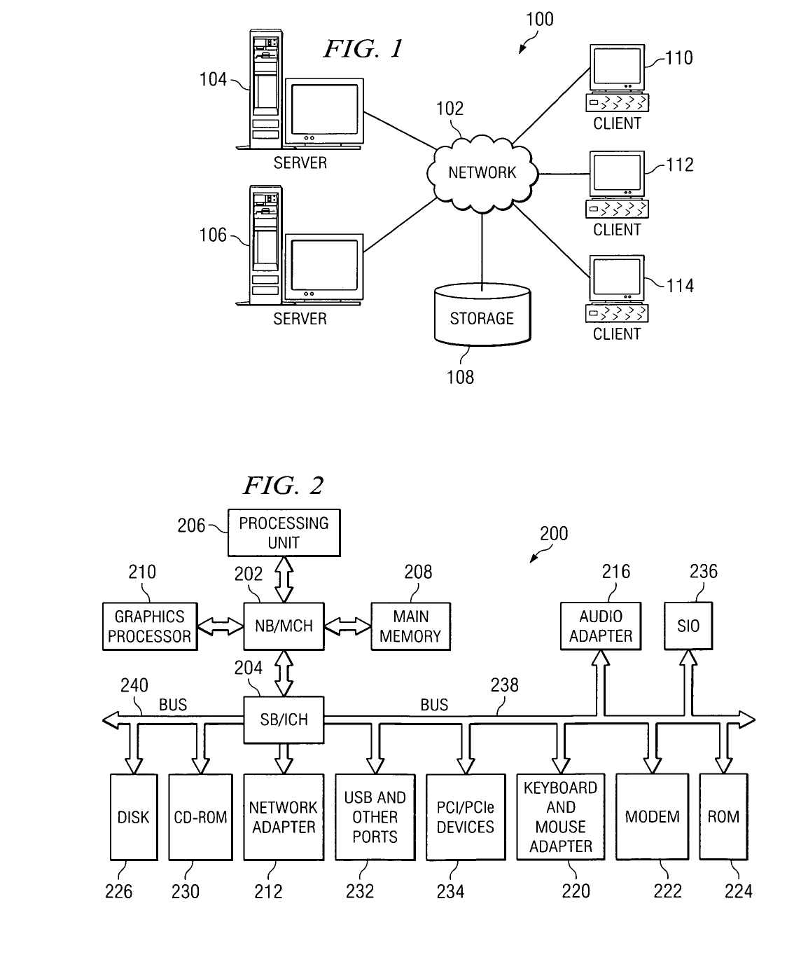

FIGS. 1-2 are provided as exemplary diagrams of data processing environments in which embodiments may be implemented. It should be appreciated that FIGS. 1-2 are only exemplary and are not intended to assert or imply any limitation with regard to the environments in which aspects or embodiments may be implemented. Many modifications to the depicted environments may be made without departing from the spirit and scope of the illustrative embodiments.

With reference now to the figures, FIG. 1 depicts a pictorial representation of a network of data processing systems in which embodiments may be implemented. Network data processing system 100 is a network of computers or data processing systems in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation.

With reference now to FIG. 2, a block diagram of a data processing system is shown in which embodiments may be implemented. Data processing system 200 is an example of a computer, such as server 104 or client 110 in FIG. 1, in which computer usable code or instructions may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eserver, pseries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. Processes are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes described herein may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for transmission of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer-implemented method, computer usable program code, and apparatus for maximizing labor value in an organization. Labor value is the financial and/or market recognized gain that an organization receives from the financial investments the organization makes in its labor force. These investments can be in terms of salary, benefits, training, and other forms of compensation and investments. In the illustrative examples, professional development analysis software decouples capability level from cost by defining a skills value index that relates the capabilities of one or more employees in an organization with the costs associated with having those one or more employees. The skills value index can be calculated for an entire organization, parts of an organization, or individuals in an organization. Thus, capability level measures and cost measures can be separated to allow independent focus on growing employee skills and recognizing value without automatically growing costs.

An exemplary method includes determining a capability level score for an individual in an organization, determining a corresponding labor cost score for the individual, and computing an individual skills value index for the individual. The individual skills value index is the ratio of the capability level score to the labor cost score. The individual skill value index is used to maximize the labor value.

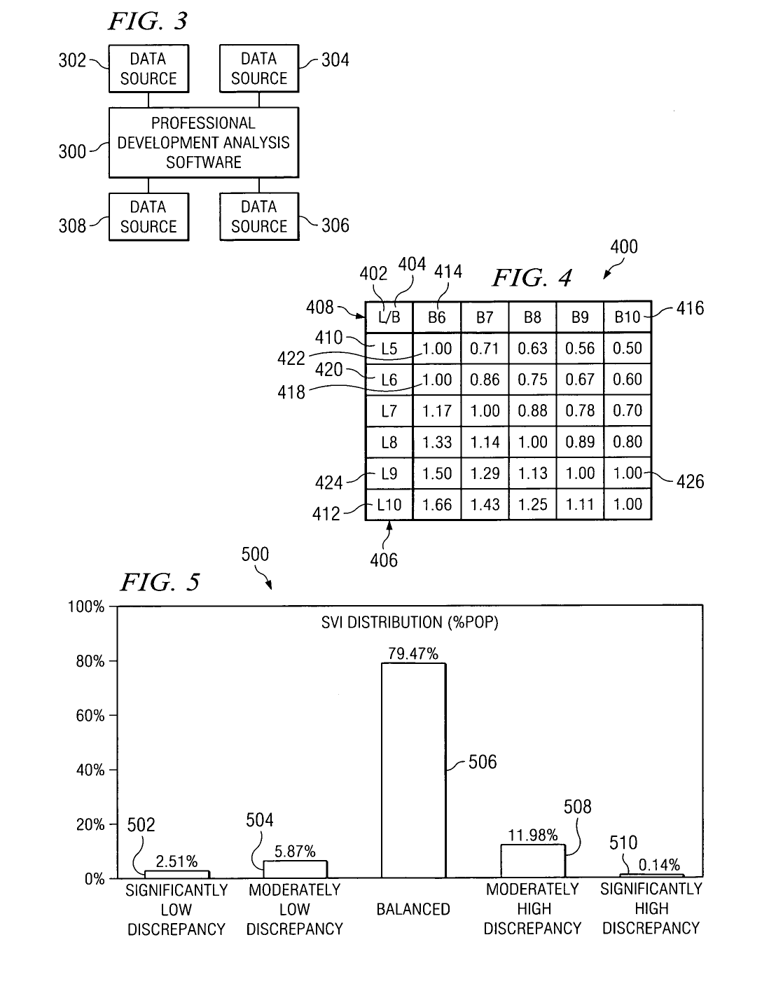

FIG. 3 is a block diagram showing operation of professional development analysis software, in accordance with an illustrative embodiment. Professional development analysis software 300 can be executed on one or more data processing systems, such as clients 110, 112, or 114, or such as servers 104 or 106. Professional development analysis software 300 can also be executed on more than one data processing system simultaneously, communicating via a network such as network 102. Similarly, professional development analysis software 300 can receive data from a variety of sources via network 102. For example, Professional development analysis software 300 can receive data from sources such as data source 302, data source 304, data source 308, and/or data source 306.

Professional development analysis software 300 assists an organization to manage its workforce. However, traditional professional development analysis software binds the capability level of individuals in an organization to the cost of employing those individuals. In other words, high capability level correlates to high cost and low capability level correlates to low cost.

Unfortunately, this type of bound construct used in traditional professional development analysis software results in an inability to holistically analyze the relationship of capability level to cost. As a result, mismatches between an individual employee's capability level and the cost associated with maintaining the employee can occur. Consequently, undesirable outcomes can result for the organization.

For example, the illustrative embodiments recognize that undesirable voluntary attrition can occur among high capability level employees who do not receive enough compensation. Similarly, the illustrative embodiments recognize that loss of revenue, utilization, or customer satisfaction problems can occur in employees with a low capability level that receive too much compensation. Likewise, the illustrative embodiments recognize that a glut of higher paid employees in higher positions can block advancement for highly skilled individuals in lower positions. Employee discontent can increase with regard to career development and professional development. Other problems can also arise. Hence, the illustrative embodiments recognize that traditional professional development analysis software does not adequately assist an organization to efficiently manage its employees in terms of employee cost and employee capability level.

These problems can be addressed successfully as described herein. In an illustrative example, professional development analysis software 300 is improved by decoupling employee capability level and employee cost and then using new techniques to analyze the unbound relationship between employee capability level and employee cost. Thus, the illustrative embodiments described herein provide insight into an organization which could not be achieved with traditional versions of professional development analysis software. The insight gained can allow a business to more efficiently preserve a highly skilled and motivated workforce, while simultaneously minimizing costs associated with that workforce.

In an illustrative example, professional development analysis software 300 contains computer usable program code to define a skills value index. The skills value index is the average of a capability level score of an individual in an organization divided by a labor cost score for that individual. The capability level score reflects the capabilities of an individual or employee, as described further below. The labor cost score reflects how much money must be spent to maintain the individual or employee in terms of salary, overhead, and benefits.

Different kinds of skills value indices can be determined at various levels within an organization. For example, an organization-wide skills value index is the canonical average of all employees' capability level scores within a given organization divided by the canonical average of all employees labor cost scores within the same organization. Thus, the organization-wide skills value index measures the aggregate value of the relationship of capability levels to cost levels across an organization. In this case, the skills value index is a metric that describes the overall value of all employees' skills relative to the cost the organization is paying for those skills.

In another illustrative example, an individual skills value index can be calculated for a particular individual or employee. For example, the capability level score of an individual is divided by the labor cost score to maintain that individual. The resulting individual skills value index can be compared to other individual skills value indices, to an organization-wide skills value index, or to other types of skill value indices in order to draw conclusions regarding the particular individual's relative capabilities in an organization or sub-organization.

In another illustrative example, a sub-organization skills value index can be calculated for a sub-organization within an overall organization. For example, a sub-organization skills value index can be generated for a research and development department within a large business. In this case, the sub-organization skills value index is the canonical average of the capability level scores within the sub-organization divided by the average labor cost scores of individuals within the sub-organization. In other embodiments, an industry-wide skills value index can be estimated for an entire industry. In this case, the organization-wide skills value index can be compared to the industry-wide skills value index to gain additional information regarding the health of an organization. Other examples of the types of skills value indices and the uses of skills value indices are described with respect to FIG. 4 through FIG. 6 and elsewhere herein.

Capability level scores for individuals or employees are generated using techniques known in the art. For example, the Links Group offers a service called skill cost alignment, describe in part at linksgroup.net. Employee labor cost scores are measured in terms of the total dollars spent on employee salaries, benefits, other forms of compensation, and on the overhead required to maintain the employee. Both employee capability level scores and employee labor cost scores can be derived from one or more of data source 302, data source 304, data source 306, data source 308, or some other source of data.

A skills value index can be used to optimize labor value versus labor cost in an organization. In an illustrative example, a method for optimizing labor value versus labor cost includes first defining an organization-wide skills value index for an organization. Professional development analysis software 300 can also determine one or more individual skills value indices or one or more sub-organizational skills value indices. Next, professional development analysis software 300 uses one or more of the various types of skills value indices as metrics that can be used to interpret the position of an organization in regards to the alignment between employee capability levels and employee labor cost scores, career development of individuals in the organization, and overall professional development of individuals in the organization. Optionally, professional development analysis software 300 analyzes the potential causes of mismatches between employee capability levels and employee labor cost scores with regards to particular individuals in the organization or with regard to sub-organizations within an organization. Professional development analysis software 300 can also generate recommendations for remediating mismatches between employee pay level and capability level at an individual level, sub-organization level, organization-wide level, or industry-wide level.

Remediation of mismatches in employee capability level scores and employee labor cost scores can take a number of forms, depending on the nature of the mismatch. For example, employees whose capability level score, or skill level, surpasses average employee labor cost scores for a given pay level can be rewarded. Reward can take the form of increased compensation, recognition by management or peers, one time bonuses, or promotion within the organization. In another example, an employee whose capability level score slightly lags behind the average employee labor cost score for a given pay level can be retrained. In another example, an employee whose capability level score greatly lags behind the average employee labor cost score for a given pay level can be redeployed. These individuals can be redeployed to other areas in an organization which better fit their skill set. In yet another example, employees that have sufficiently low capability level scores relative to the average employee labor cost score for a given pay level can be removed from the organization.

FIG. 4 is a table showing an exemplary normalized skill value indices that compare normalized capability level scores to normalized labor cost scores, in accordance with an illustrative embodiment. The table shown in FIG. 4 can be determined using professional development analysis software 300, or can be determined manually by a user. If professional development analysis software is used to determine the table shown in FIG. 4, then a data processing system such as data processing system 100 in FIG. 1 or data processing system 200 in FIG. 2 can be used to execute the professional development analysis software.

In table 400 shown in FIG. 4, the symbol “L” 402 refers to a range of capability level scores. In table 400, the symbol “B” 404 refers to a band or a range of labor cost scores. Thus, columns, such as column 406 refer to an exemplary normalized set of capability level scores. Similarly, rows, such as row 408, refer to an exemplary normalized set of labor cost scores.

Levels and bands are not necessarily related to each other, and any number of capability level scores and/or labor cost scores can be used. In this illustrative example, capability level scores vary from L5 410 to L10 412 and labor cost scores vary from B6 414 to B10 416. The numbers in the remaining cells of the table reflect normalized values for a skills value index. Again, the skills value index is a capability level score divided by a labor cost score.

The values shown in the table in FIG. 4 are normalized in that when a level equals a band, such as at cell 418 corresponding to L6/B6, then the capability level score is equal to the labor cost score. Thus, for example, an individual with skills adequate to perform at band B6 414 that has a cost commensurate with level L6 420 is assumed to have a balanced skills value index. For this reason, a value of “1.00” in the table shown in FIG. 4 is considered balanced.

In contrast, a significant discrepancy occurs if the value shown in the table is between 0.0 and 0.86. In this case, the capability level score is much less than the labor cost score. If an individual or organization has a skills value index between 0.0 and 0.86, then that individual or organization has a labor cost score that is far in excess of the capability level score of that individual. A similar moderate discrepancy occurs if the skills value index is between 0.87 and 0.97. Although these ranges are exemplary, the exact determination of what discrepancy is considered “significant” or “moderate” is made by a human or by a data processing system according to its programming. Thus, the values described above can differ significantly in terms of characterizing them as moderate, significant, or some other characterization. Additionally, a “balanced” skill value index can be established in any desired range, including but not limited to a range between about 0.98 and 1.02.

Another significant discrepancy can occur if the value shown in the table is between 1.18 and 2.0. In this case, the capability level score is much greater than the labor cost score. If an individual or organization has a skills value index between 1.18 and 2.0, then that individual or organization has a labor cost score that is far less than the capability level score of that individual. A similar moderate discrepancy occurs if the skills value index is between 1.03 and 1.17. Although these ranges are exemplary, the exact determination of what discrepancy is considered “significant” or “moderate” is made by a human or by a data processing system according to its programming. Thus, the values described above can differ significantly in terms of characterizing them as moderate, significant, or some other characterization.

Additionally, individual exceptions can be created for a particular normalized skills value index chart. For example, in the table shown in FIG. 4, an individual with capabilities at B6 414 that has a cost commensurate with L5 410 (cell 422) is also considered balanced. In this case, band B6 414 is considered a “new hire” band designation and any individual at an entry cost level L5 410 or cost level L6 420 is considered balanced. In another example, an individual with capabilities at B10 416 but only cost level L9 424 (cell 426) is also considered balanced. In this case, the level L9 424/band B10 416 pair (cell 426) is viewed as balanced because band level B10 416 is the terminal level on a career path in an organization.

FIG. 5 is a graph showing an exemplary skills value index distribution for an organization, in accordance with an illustrative embodiment. The bars shown in FIG. 5 represent an accumulation of individual skills value indices for an entire organization or sub-organization. In another example, the bands represent an accumulation of sub-organizations for an entire organization. In any case, the skills value index (SVI) distribution shown in FIG. 5 can be presented using a data processing system, such as data processing system 100 in FIG. 1 or data processing system 200 shown in FIG. 2. Individual skills value indices can be determined according to the methods described with respect to FIG. 3.

In the exemplary graph shown in FIG. 5, a separate skills value index is determined for all individuals within an organization in accordance with an illustrative embodiment. Graph 500 in this illustrative example therefore represents a graph of a distribution of skills value indices of all individuals across an organization. Individuals with skills value indices that are considered to have a “significantly low discrepancy,” as described with respect to FIG. 4, are grouped together. Individuals with a “significantly low discrepancy” are considered to have capability level scores much higher than their corresponding labor cost scores. In one example, these individuals are paid much too little for their skills, though in other examples other reasons exist for the significant discrepancy. Similarly, individuals with skills value indices that are considered to have a “moderately low discrepancy,” as described with respect to FIG. 4 are grouped together. Individuals with balanced skills value indices are also grouped together, as are individuals that are considered to have skills value indices that are moderately high and as are individuals with that are considered to have skills value indices that are significantly high. Individuals that are considered to have skills value indices that are high have capability level scores less than their labor cost scores. In one example, these individuals are paid too much for their skills, though in other examples other reasons exist for the discrepancy.

Thus, graph 500 in FIG. 5 represents five groups of individuals, as shown by bar 502 (significantly low discrepancy in skills value indices), bar 504 (moderately low discrepancy in skills value indices), bar 506 (balanced skills value indices), bar 508 (moderately high discrepancy in skills value indices), and bar 510 (significantly high discrepancy in skills value indices). In the illustrative example shown in FIG. 5, bar 502 shows that 2.51 percent of individuals in an organization have a significantly low discrepancy in skills value indices, 5.87 percent of individuals have a moderately low discrepancy in skills value indices, 79.47 percent of individuals have balanced skills value indices, 11, 98% of individuals have moderately high discrepancy in skills value indices, and 0.14% of individuals have significantly high discrepancy in skills value indices.

A user can use the information portrayed in graph 500 of FIG. 5 to draw conclusions about the organization. In the illustrative example, an organization ideally has 100% of individuals having balanced skills value indices. Thus, the user can see from graph 500 of FIG. 5 that various individuals should be examined more closely in order to bring individuals with unbalanced skills value indices to have balanced skills value indices. The process of adjusting individuals with discrepant skills value indices can be referred to as remediation. Remediation is described in more detail below.

As described above, skills value indices can be determined for sub-organizations within an overall organization. Thus, each bar in graph 500/could represent groups of sub-organizations. However, each bar can represent an individual skills value index for an individual sub-organization. In this way, a user can immediately determine that a sub-organization having a high or low skills value index requires attention at more than an individual level.

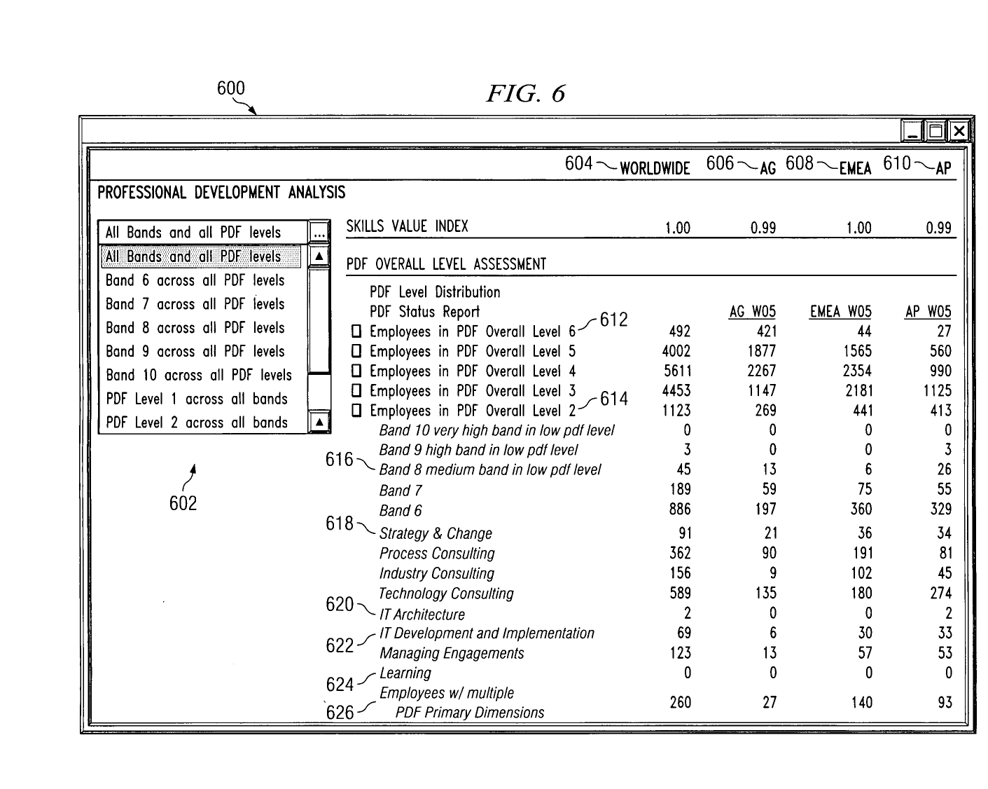

FIG. 6 is an exemplary graphical user interface for professional development analysis software that is capable of calculating and manipulating a skills value index for an organization, in accordance with an illustrative embodiment. Graphical user interface 600 shown in FIG. 6 is an example of an interface for professional development software, such as professional development software 300 in FIG. 3. Graphical user interface 600 shown in FIG. 6 can be executed on one or more data processing systems, such as data processing system 100 shown in FIG. 1 and data processing system 200 shown in FIG. 2.

Graphical user interface 600 can display information regarding individual skills value indices, sub-organizational skills value indices, and an organization-wide skills value index. For example, data can be input into the professional development software regarding various individuals' capability level scores and cost level scores. Graphical user interface 600 can then display that information in a manner of use to a user.

For example, a user can use drop-down menu 602 to display a particular labor cost score, referred to as a band, for a particular capability level score, referred to as a professional development framework or PDF. Thus, for example, a user could select to display all bands and all PDF levels, as shown by the highlighted portion of drop-down menu 602. However, a user could choose to display only certain information, such as band 10 across all PDF levels or a particular PDF level across one or more bands.

Additionally, professional development software 600 can display skills value indices, and various discrepancy levels, for sub-organizations within an organization and for the overall organization itself. For example, graphical user interface 600 shows one overall organization, “worldwide” 604, and three sub-organizations, “AG” 606, “EMEA” 608, and “AP” 610.

Graphical user interface 600 also shows a variety of information regarding overall organization 604 and each sub-organization 606, 608, and 610. In the illustrative example shown, graphical user interface 600 shows the number of employees in having a particular capability level score (or PDF). For example, line 612 shows the number of employees having a high capability level score (PDF level 6). Line 614 shows the number of employees having a low capability level score (PDF level 2).

Graphical user interface 600 also can show the number of employees at a particular band within a PDF level. For example, sub-information below line 614 includes line 616, which describes the number of individuals having a high labor cost score (band 8) within a low capability level score (PDF level 2). This category includes individuals having skills value indices that are highly discrepant. Additionally, this category includes individuals a high labor cost for only a low capability level. Worldwide, or organization level 604, 45 individuals fall within this category. However, a user can also easily see that of those 45 individuals, 26 are within sub-organization “AP” 610. Because over half of the individuals having a high discrepancy in skills value indices are in sub-organization “AP” 610, a systemic problem may be present in sub-organization “AP” 610.

Graphical user interface 600 can also be used to display further sub-divisions of organizations. For example, as described above, worldwide overall organization 604 includes sub-organizations 606, 608, and 610. However, each of these sub-organizations include one or more sub-organizations, including various departments such as “strategy and change” 618, “IT Architecture” 620, and “IT Development and Implementation” 622. Professional development software 600 can also display other relevant information, such as the number of employees currently engaged in learning in line 624 or the number of employees with multiple capability level scores (PDF primary dimensions) in line 626.

Thus, professional development software 300 can determine and graphical user interface 600 can display various information derived from one or more skills value indices of individuals, sub-organizations, or an overall organization. Users can use the displayed information to judge the overall health of an organization and determine where best to allocate management resources to increase the efficiency of an organization. Graphical user interface 600 can also be used to make decisions regarding hiring or out-sourcing. In the example shown in FIG. 6, “IT Development and Implementation” 622 has only a few individuals. The organization could therefore decide to train or hire more individuals to be included in this sub-organization. On the other hand, the numbers shown in FIG. 6, line 622 could indicate the results of prior analysis and decision making for staff augmentation with lower priced resources at a low capability level score (PDF level 2) where only entry level skills are needed.

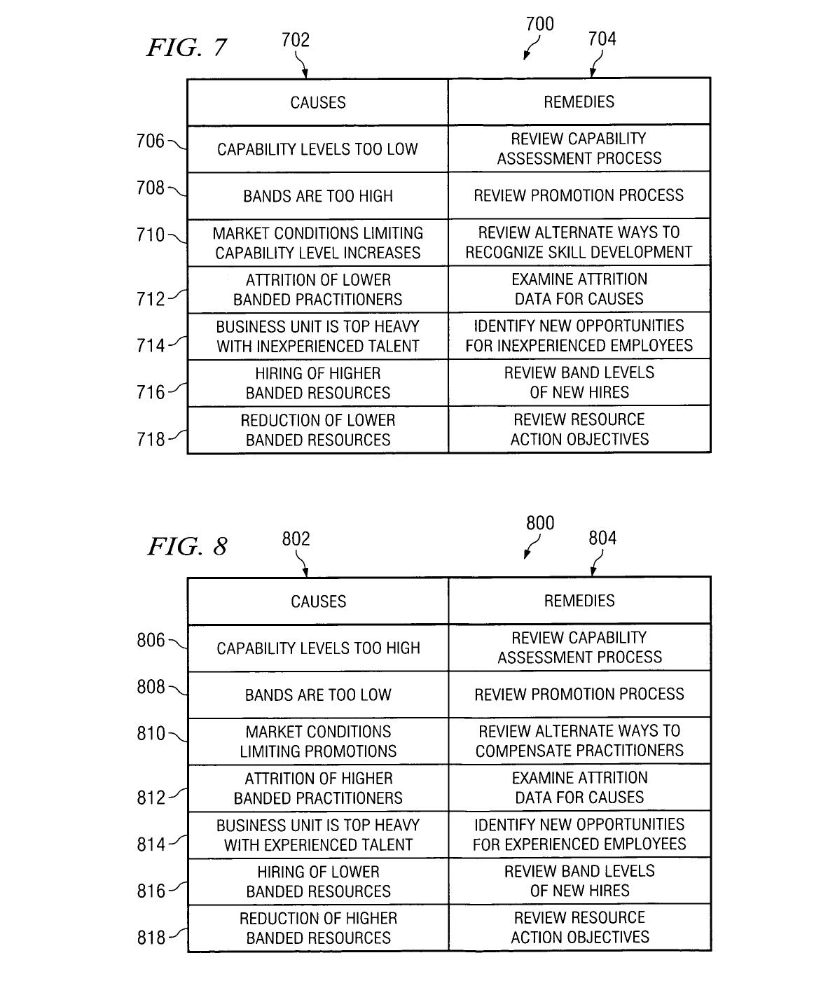

FIG. 7 is a table showing exemplary causes and remedies for misalignment between capability level scores and labor cost scores, in accordance with an illustrative embodiment. Table 700 shown in FIG. 7 can be generated and/or displayed in professional development software, such as professional development software 600 shown in FIG. 6. Thus, the table shown in FIG. 7 can be generated and manipulated using a data processing system, such as data processing system 100 shown in FIG. 1 and data processing system 200 shown in FIG. 2.

In the illustrative example shown in FIG. 7, table 700 is divided into column 702 and column 704. Column 702 shows a list of possible causes of misalignment between capability level scores and labor cost scores. Column 704 shows a list of possible remedies for the misalignment. Each row lists a potential cause of misalignment matched with a potential remedy for that cause. Although table 700 in FIG. 7 associates one possible remedy with one possible cause, multiple causes and multiple remedies can be associated with each other. Additionally, numerous additional possible causes of misalignment and corresponding remedies exist.

For example, row 706 through 718 show exemplary possible causes of misalignment between capability level scores and labor cost scores associated with possible remedies. Row 706 shows that if capability level scores are too low, then a user can implement a remedy of reviewing the process of assessing capability level scores. In this case, a flaw may exist in the process of determining capability level scores that, if present, should be corrected. Another possible remedy would be to provide additional training to employees, assuming that capability level scores are accurate.

Additionally, row 708 shows that if labor cost scores (bands) are too high, then a user can implement a remedy of reviewing the process of promoting employees. In this case, the user searches for reasons why too many employees have been promoted and can take corrective action accordingly. Row 710 shows that if market conditions limit increases in capability level scores, then a user can implement the remedy of reviewing alternate methods of recognizing skill development. Row 712 shows that if attrition of individuals with lower labor cost scores (banded practitioners) is too high, then a user can implement the remedy of examining attrition data for causes of the attrition rate observed. Row 714 shows that if an organization or sub-organization (business unit) has too many individuals with low capability level scores (top heavy with inexperienced talent), then a user can implement the remedy of identifying new opportunities for inexperienced employees. Row 716 shows that an organization is hiring too many individuals with high labor cost scores (higher banded resources), then a user can implement the remedy of reviewing or lowering labor cost scores for all new hires. Row 718 shows that if reduction occurs among individuals with lower labor cost scores (reduction of lower banded resources), then a user can implement the remedy of reviewing and/or modifying resource action objectives.

In the illustrative example, professional development software can display one or more causes of misalignment and/or recommend one or more possible remedies in a manner consistent with data provided to the professional development software. Thus, for example, if the professional development software determines that labor cost scores outpace capability level scores, then professional development software can automatically display to a user the possible cause and one or more possible remedies.

FIG. 8 is a table showing exemplary causes and remedies for misalignment between capability level scores and labor cost scores, in accordance with an illustrative embodiment. The table shown in FIG. 8 can be generated and/or displayed in professional development software, such as professional development software 600 shown in FIG. 6. Thus, the table shown in FIG. 8 can be generated and manipulated using a data processing system, such as data processing system 100 shown in FIG. 1 and data processing system 200 shown in FIG. 2. Although table 800 in FIG. 8 associates one possible remedy with one possible cause, multiple causes and multiple remedies can be associated with each other. Additionally, numerous additional possible causes of misalignment and corresponding remedies exist.

In the illustrative example shown in FIG. 8, table 800 is divided into column 802 and column 804. Column 802 shows a list of possible causes of misalignment between capability level scores and labor cost scores. Column 804 shows a list of possible remedies for the misalignment. Each row lists a potential cause of misalignment matched with a potential remedy for that cause. Although table 800 in FIG. 8 associates one possible remedy with one possible cause, multiple causes and multiple remedies can be associated with each other. Additionally, numerous additional possible causes of misalignment and corresponding remedies exist.

For example, row 806 through 816 show exemplary possible causes of misalignment between capability level scores and labor cost scores associated with possible remedies. Row 806 shows that if capability level scores are too high, then a user can implement a remedy of reviewing the process of assessing capability level scores. In this case, a flaw may exist in the process of determining capability level scores that, if present, should be corrected. Another possible remedy would be to increase employee pay, assuming that capability level scores are accurate.

Additionally, row 808 shows that if labor cost scores (bands) are too low, then a user can implement a remedy of reviewing the process of promoting employees. In this case, the user searches for reasons why not enough employees have been promoted and can take corrective action accordingly. Row 810 shows that if market conditions limit increases in capability level scores, then a user can implement the remedy of reviewing alternate methods of compensating employees. Row 812 shows that if attrition of individuals with high labor cost scores (banded practitioners) is too high, then a user can implement the remedy of examining attrition data for causes of the attrition rate observed. Row 814 shows that if an organization or sub-organization (business unit) has too many individuals with high capability level scores (top heavy with experienced talent), then a user can implement the remedy of identifying new opportunities for experienced employees. Row 816 shows that an organization is hiring too many individuals with low labor cost scores (lower banded resources), then a user can implement the remedy of reviewing or increasing labor cost scores for all new hires. Row 818 shows that if reduction occurs among individuals with higher labor cost scores (reduction of higher banded resources), then a user can implement the remedy of reviewing and/or modifying resource action objectives.

In the illustrative example, professional development software can display one or more causes of misalignment and/or recommend one or more possible remedies in a manner consistent with data provided to the professional development software. Thus, for example, if the professional development software determines that capability level scores outpace labor cost scores, then professional development software can automatically display to a user the possible cause and one or more possible remedies.

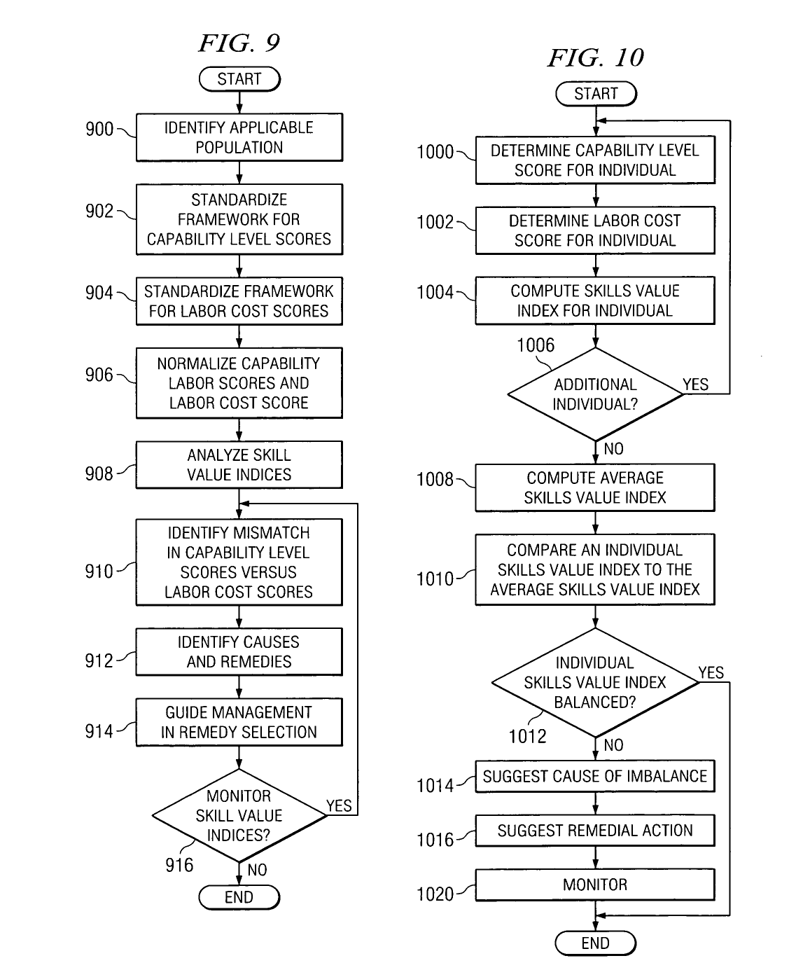

FIG. 9 is a flowchart illustrating an exemplary method of comparing capability level scores and labor cost scores, in accordance with an illustrative embodiment. The process shown in FIG. 9 can be implemented using professional development analysis software, such as professional development analysis software 300 described in FIG. 3 having a user interface, such as graphical user interface 600 shown in FIG. 6. In turn, the professional development analysis software can be executed on one or more data processing systems, such as data processing system 100 in FIG. 1 or data processing system 200 in FIG. 2.

The process begins as professional development analysis software identifies an applicable population (step 900). An applicable population can be a group of individuals within an organization or a sub-organization, and can also be an individual. Next, professional development analysis software standardizes a framework of capability level scores (step 902).

For example, all individuals within the applicable population could fall within one of six different capability level scores, as shown in FIG. 4. Professional development analysis software then standardizes a framework for labor cost scores (step 904). For example, all individuals within the applicable population could fall within one of five different labor cost scores, as shown in FIG. 4. Thereafter, professional development analysis software normalizes the capability level scores and/or the labor cost scores (step 906). An example of a table showing normalized capability level scores and labor cost scores is shown in FIG. 4. Professional development analysis software then analyzes the ratio of the capability level score and labor cost score for each individual in the applicable population (step 908). Each ratio can be referred to as an individual skills value index.

Using the normalized table of capability level scores and labor cost scores as well as the individual skills value indices, professional development analysis software can then identify mismatches between individual capability level scores and individual labor cost scores (step 910). In other words, professional development analysis software can identify mismatches between individual skill value indices as compared to the normalized table of skill value indices.

Optionally, professional development analysis software can identify possible causes of mismatches in skill value indices and also suggest possible remedies for the mismatches (step 912). Examples of possible causes of mismatches in skill value indices and also possible remedies for the mismatches are shown in FIG. 7 and FIG. 8. Similarly, and also optionally, professional development analysis software can guide users, such as a management team, in selecting a particular remedial action or set of remedial actions (step 914).

Professional development analysis software can then determine, based on user input, whether to monitor the ratio of the capability level scores to the labor cost scores (step 916). In other words, professional development analysis software determines, based on user input, whether to monitor individual skills value indices against the normalized table of skills value indices. If further monitoring is desired, then the process returns to step 910 and repeats thereafter until no further monitoring is desired. If further monitoring is not desired, then the process terminates.

FIG. 10 is a flowchart illustrating an exemplary method of comparing capability level scores and labor cost scores, in accordance with an illustrative embodiment. The process shown in FIG. 10 can be implemented using professional development analysis software, such as professional development analysis software 600 described in FIG. 6. In turn, the professional development analysis software can be executed on one or more data processing systems, such as data processing system 100 in FIG. 1 or data processing system 200 in FIG. 2.

The process begins as professional development analysis software determines a capability level score for an individual (step 1000). The professional development analysis software then determines a labor cost score for that individual (step 1002). The process of determining capability level scores and labor cost scores is described with respect to FIG. 3. The professional development analysis software then computes a skills value index for that individual (step 1004). The skills value index is a ratio of the capability level score to the labor cost score.

The professional development analysis software then determines if additional individuals should be evaluated (step 1006). If additional individuals are to be evaluated, then the process returns to step 1000 where the process described above repeats. In this illustrative example, more than one individual is evaluated such that more than one skills value index is determined. If no more additional individuals are to be evaluated, then the professional development analysis software computes an average skills value index (step 1008). The average skills value index can be the canonical average of the capability level score of all individuals previously evaluated through step 1006 compared to the canonical average of the labor cost score of all individuals previously evaluated through step 1006. The average skills value index can also be a normalized table of skills value indices, such as the table shown in FIG. 4.

In either case, the professional development analysis software compares one or more individual skill value indices to the averages skills value index, which can be a normalized table of skills value indices (step 1010). The professional development analysis software then determines whether the individual or individuals' skills value indices are balanced (step 1012). An individual skills value index is balanced if the individual skills value index is about equal to the average skills value index. An individual skills value index is also balanced if the individual skills value index is about equal to 1.00 when compared to a set of normalized skills value indices, such as the set shown in the table of FIG. 4. The term “about equal” is determined by the user, but can vary in the range of about 5% or more to about 0%.

If the individual skills value index is not equal, then the professional development analysis software optionally suggests a cause of the imbalance (step 1014). Similarly, the professional development analysis software can suggest a remedial action to be taken to correct the imbalance (step 1016). Thereafter, or if the individual skills value index was balanced in step 1012, then the professional development analysis software can continue to monitor individual skills value indices (step 1020). If monitoring is complete, or if further monitoring is not desired, then the process terminates.

The process shown in FIG. 10 can be extended to comparing skills value indices for sub-organizations within an organization. For example, professional development analysis software can compute a sub-organization skills value index by computing the ratio of the canonical average of all capability level scores within the sub-organization to the canonical average of all labor cost scores within the sub-organization. The sub-organization skills value index can then be compared to a normalized table of skills value indices, as described above, or to an average of all skills value indices of all sub-organizations within an organization, as described above. Thus, the process shown in FIG. 10 can be applied to sub-organizations within an organization, as well as to individuals within a sub-organization or an overall organization.

The illustrative embodiments described herein provide several important advantages over known methods for optimizing the relationship between employee capability levels versus employee costs. First, the illustrative embodiments provide an end-to-end integrated process to balance capability and cost, whereas known systems only provide individual parts of the overall process. Second, the illustrative embodiments described herein rely on separate standardized measures for employee capability levels and employee costs, enabling fast and accurate evaluation of each measure independently. Thus, the illustrative embodiments described herein avoid the pitfall of assuming that all individuals within a job role possess a similar level of skill. Third, the standardization of measures of the illustrative embodiments described herein facilitate capability level versus cost comparisons from an enterprise view down to the individual level. Fourth, the illustrative embodiments equip organizations with the capability of continuously monitoring and managing the relationship between employee capability level and employee cost.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method for generating maximizing labor value, the computer implemented method comprising:
determining a capability level score for an individual in an organization;
determining a corresponding labor cost score for the individual; and
computing an individual skills value index for the individual, wherein the individual skills value index is the ratio of the capability level score to the labor cost score, wherein the individual skill value index is used to maximize the labor value.

2. The computer-implemented method of claim 1 further comprising:
performing the steps of determining a corresponding capability level score and determining a corresponding labor cost score for a plurality of individuals in the organization;
calculating an average capability level score of the plurality of individuals;
calculating an average labor cost score of the plurality of individuals; and
computing an average skills value index for the plurality of individuals in the organization, wherein the average skills value index is the ratio of the average capability level score to the average labor cost score.

3. The computer-implemented method of claim 2 further comprising:
determining, based on the average skills value index, whether the organization has a balanced labor value.

4. The computer-implemented method of claim 3 further comprising:
responsive to a determination that the organization does not have a balanced labor value, determining an action to be recommended.

5. The computer-implemented method of claim 4 wherein the action is selected from the group consisting of analyzing which sub-organizations within the organization do not have a balanced labor value, determining which individuals within the organization do not have a balanced labor value, and implementing a skill development plan for at least one individual within the organization.

6. The computer-implemented method of claim 2 further comprising:
comparing the individual skills value index to the average skills value index.

7. The computer-implemented method of claim 6 further comprising:
responsive to a determination that the individual skills value index is different than the average skills value index, determining a remedial action to be recommended with respect to the individual.

8. The computer-implemented method of claim 7 wherein the remedial action is selected from the group consisting of rewarding the individual, re-training the individual, re-deploying the individual, and removing the individual.

9. A computer program product comprising:
a computer usable medium having computer usable program code, said computer program product including:
computer usable program code for determining a capability level score for an individual in an organization;
computer usable program code for determining a corresponding labor cost score for the individual; and
computer usable program code for computing an individual skills value index for the individual, wherein the individual skills value index is the ratio of the capability level score to the labor cost score, wherein the individual skill value index is used to maximize the labor value.

10. The computer program product of claim 9 further comprising:
computer usable program code for performing the steps of determining a corresponding capability level score and determining a corresponding labor cost score for a plurality of individuals in the organization;
computer usable program code for calculating an average capability level score of the plurality of individuals;
computer usable program code for calculating an average labor cost score of the plurality of individuals; and
computer usable program code for computing an average skills value index for the plurality of individuals in the organization, wherein the average skills value index is the ratio of the average capability level score to the average labor cost score.

11. The computer program product of claim 10 further comprising:
computer usable program code for determining, based on the average skills value index, whether the organization has a balanced labor value.

12. The computer program product of claim 10 further comprising:
computer usable program code for comparing the individual skills value index to the average skills value index.

13. The computer program product of claim 12 further comprising:
computer usable program code for, responsive to a determination that the individual skills value index is different than the average skills value index, determining a remedial action to be recommended with respect to the individual.

14. The computer program product of claim 13 wherein the remedial action is selected from the group consisting of rewarding the individual, re-training the individual, re-deploying the individual, and removing the individual.

15. A data processing system comprising:
a processor;
a bus connected to the processor;
a computer usable medium connected to the bus, wherein the computer usable medium contains a set of instructions, wherein the processor is adapted to carry out the set of instructions to:
determine a capability level score for an individual in an organization;
determine a corresponding labor cost score for the individual; and
compute an individual skills value index for the individual, wherein the individual skills value index is the ratio of the capability level score to the labor cost score, wherein the individual skill value index is used to maximize the labor value.

16. The data processing system of claim 15 wherein the processor is further adapted to carry out the set of instructions to:
perform the steps of determining a corresponding capability level score and determining a corresponding labor cost score for a plurality of individuals in the organization;
calculate an average capability level score of the plurality of individuals;
calculate an average labor cost score of the plurality of individuals; and
compute an average skills value index for the plurality of individuals in the organization, wherein the average skills value index is the ratio of the average capability level score to the average labor cost score.

17. The data processing system of claim 16 wherein the processor is further adapted to carry out the set of instructions to:
determine, based on the average skills value index, whether the organization has a balanced labor value.

18. The data processing system of claim 16 wherein the processor is further adapted to carry out the set of instructions to:
compare the individual skills value index to the average skills value index.

19. The data processing system of claim 18 wherein the processor is further adapted to carry out the set of instructions to:
responsive to a determination that the individual skills value index is different than the average skills value index, determine a remedial action to be recommended with respect to the individual.

20. The data processing system of claim 19 wherein the remedial action is selected from the group consisting of rewarding the individual, re-training the individual, re-deploying the individual, and removing the individual.
